(19) United States
(12) Patent Application Publication
(10) Pub. No.: US 2018/0202416 A1
(43) Pub. Date: Jul. 19, 2018

(54) DAMLESS HYDROELECTRIC POWER PLANT

(71) Applicants: VIKTOR IVANOVICH KRIVCHIKOV, LUGANSK (UA); DMYTRIY IVANOVICH AKISHIN, KIEV (UA)

(72) Inventors: VIKTOR IVANOVICH KRIVCHIKOV, LUGANSK (UA); DMYTRIY IVANOVICH AKISHIN, KIEV (UA)

(21) Appl. No.: 15/740,757

(22) PCT Filed: Sep. 21, 2015
(86) PCT No.: PCT/UA2015/000088

§ 371 Date: Dec. 28, 2017

(30) Foreign Application Priority Data
Aug. 25, 2015 (UA) A 2015 08384

(51) Int. Cl. F03B 17/06; F03B 7/00

(52) U.S. Cl. CPC F03B 17/063; Y02E 10/28; F05B 2210/11; F03B 7/00

(57) ABSTRACT

A damless hydroelectric power plant can be used in installations for converting the kinetic energy of a gravity flow of water into electrical energy. A part of the housing of the hydroelectric power plant, in which the bladed wheel is placed, is in the form of an annular tunnel. Annular support guides on which the bladed wheel is supported are fixed in several rows on vertical struts of the tunnel inside the latter on both sides thereof. The annular tunnel structure is connected to a central bushing through tension members and to the containers, some of which contain a constant volume of air, while the others contain an adjustable volume of air. In each wheel sector, the bladed wheel comprises several rows of support rollers fixed on the vertical struts on the outside of the outer and inner wheel rims and having both horizontal and vertical rotation axes and provided with springs through which the wheel cooperates with the annular support guides of the tunnel, and gear sectors arranged in several rows fixed on the vertical struts of the outer wheel rim on each wheel sector and allowing for pulling the chains kinematically connected with a rotation multiplier and an electric power generator when rotating the bladed wheel.

### FIELD OF THE INVENTION

The invention relates to hydropower industry, in particular to devices for converting kinetic energy of a gravity flow of water (river, sea and ocean currents) into electrical energy.

### BACKGROUND

A known “Damless All-Season Hydroelectric Power Plant” by G. I. Ozerov comprises a horizontal bladed wheel with deployable blades, a vertical housing divided into cylinders and attached to a support in a rotating manner through the interaction between rollers and circular guides, connected with external rotary step-opening blades, whose rotation axes are shifted relative to each other at the same angle. A main and a standby electric power generators are attached to the support and connected to the housing and the gear wheel through mechanical transmission. The interior of the housing is provided with lattices, which are an extension of the external rotary blades, and with fixed internal blades formed of loosely fixed flaps resting on the lattice. The external blades are provided to ensure the internal blades overlapping in their disabled state and their early starting when enabled [see the patent of the Russian Federation No. 1836586, by class F03B, pub. Aug. 23, 1993].

The main drawbacks of the technical solution are as follows. The placement of a hydroelectric power plant in the bottom part of the flow of water, where particles of abrasive materials, such as bottom soil, are actively moving, negatively affects the functionality of the friction units, causing their premature wear. In the power plant design there are units requiring exact kinematic interaction (coupling) of the contacting parts. The multi-stage kinematic multiplication scheme reduces the efficiency of the known hydroelectric power plant.

The closest by its nature and the achieved effect, and assumed as a prior art, is a damless hydroelectric power plant with a bladed wheel and a housing mounted on a support with a central vertical part of the housing, made in the form of a hollow hermetically sealed cylinder filled with water or air as required, wherein a horizontal part of the housing which is rigidly connected to the cylinder is made in the form of a truss carrying an annular support guide for the bladed wheel support rollers, the bladed wheel rotatable around the hollow cylinder, a sprocket support of the first stage of the kinematic scheme for the torque transmission from the bladed wheel to the electric power generator, side barriers acting as input and output diffusers. [see the patent of the Russian Federation No. 2543362, by class F03B 7/10, F03B 13/10, F03B 17/06, pub. Feb. 27, 2015].

The main essential design drawback of this damless hydroelectric power plant for the use of high-capacity power unit as suggested consists in that the location of the chain drive for driving the driven shaft in accordance with the scheme given in the prior art does not ensure an even distribution of the power loads along the height of the bladed wheel, which can lead to its distortion and deformation of structural elements.

The second essential design drawback of this damless hydroelectric power plant is that the bladed wheel support rests on the only annular guide through the rollers with a horizontal rotation axis, which does not provide reliable resistance to displacement of the wheel towards the outer rim of the housing and leads to high pressure the guide is exposed to.

The third essential design drawback of this damless hydroelectric power plant is that its design does not provide reliable and uniform tight contact between the rollers with a vertical rotation axis and the cylinder surface.

The fourth essential design drawback of this damless hydroelectric power plant is that the use of only one cylinder of a large diameter and a large height in a large-scale hydroelectric power plant of a high unit capacity is economically unjustified in terms of manufacturing technology and unreasonable as a power unit structural element.

### SUMMARY OF THE INVENTION

The object of the invention is to achieve a rational distribution of forces arising during interaction of the bladed wheel with the housing of the device by reducing the pressure on the annular support guide caused by the bladed wheel weight load, to prevent the bladed wheel from distorting and deforming due to the forces transmitted by the chain transmission, to prevent horizontal shifts of the wheel, to use rationally the containers involved during transportation of the hydroelectric power plant to its operation place and its placement into a flow of water, to reduce the specific material consumption of the structure in relation to the electricity produced, to facilitate and simplify device maintenance and repair, to create an electric power generator of a high unit capacity by introducing appropriate structural changes.

The problem as set is solved by the fact that in the damless hydroelectric power plant with a housing containing an annular support guide supporting a bladed wheel with a vertical rotation axis and rotary blades, a driven sprocket support of chain transmission, diffusers for forming a flow of water passing through the bladed wheel, a container of an adjustable volume of air and anchor gears, according to the invention a part of the housing of the hydroelectric power plant, in which the bladed wheel is placed, is in the form of an annular tunnel, the annular support guides, on which the bladed wheel is supported by means of support rollers, are fixed in several rows on vertical struts of the tunnel inside the latter on both sides thereof, while the annular tunnel structure is connected to a central bushing through tension members similar to bicycle wheel spokes, and to the containers, some of which contain a constant volume of air, thereby providing the hydroelectric power plant with buoyancy, which is a bit lower than zero buoyancy, and the others contain an adjustable volume of air, allowing for locating the hydroelectric power plant inside the flow of water, wherein, in each wheel sector, the bladed wheel comprises several rows of the support rollers fixed on the vertical struts on the outside of the outer and inner wheel rims and having both horizontal and vertical rotation axes and provided with springs through which the wheel cooperates with the annular support guides of the tunnel, and gear sectors arranged in several rows fixed on the vertical struts of the outer wheel rim on each wheel sector and allowing for pulling the chains kinematically connected with a submersible rotation multiplier and a submersible electric power generator when rotating the bladed wheel.

The provided technical solution differs from the prior art in that the configuration of the part of the housing in which the bladed wheel is placed and the units of interaction between the housing and the bladed wheel are implemented according to a modified structural scheme and through the structurally different contact units located in the zone of the flow of water passing through the bladed wheel, which changes their mutual force effect, prevents the distortion of the bladed wheel structure and allows for creating damless hydroelectric power plants of large geometrical dimensions.

In particular, the housing is provided in the form of an annular tunnel, the vertical struts thereof being exposed to the loads caused by the action of the annular support guides and the weight of the bladed wheel as well as by the pressure of the flow of water affecting the bladed wheel. The rigidity of the housing is reinforced by tension members similar to the bicycle wheel spokes, by means of which it is possible to correct the circumference of the tunnel structure inner rim when mounting the damless hydroelectric power plant.

The bladed wheel is provided of an annular shape and in the zone of the flow of water passing through the bladed wheel, on the vertical struts of both rims in each bladed wheel sector it contains springs of the support rollers arranged in several rows and having both horizontal and vertical rotation axes through which it interacts with the annular support guides, located on the inner sides of the tunnel. In addition, in the zone of the flow of water passing on the vertical struts of the outer rim in each sector the bladed wheel contains gear sectors for pulling a corresponding number of branches of a step chain. The inner surface of the wheel rim is closed, and the struts are provided with stops for the bladed wheel.

The kinematic scheme of the torque transmission from the bladed wheel to the electric power generator contains a rotation multiplier for reducing the resistance to rotation of the latest high-speed stage.

To deliver the hydroelectric power plant to its operation place and to keep it within the flow of water, containers of a constant volume of air providing the device with a buoyancy somewhat less than the “zero” and containers of a variable volume of air are suggested as a more technological solution than the one of the prior art having the only large container.

All these differences from the prior art make it possible to create damless hydroelectric power plants of large geometric dimensions and high unit capacity, limited only by the strength of the constructional materials.

In the provided technical solution, the distinctive features do not characterize parts of a whole object, they can rather be whole objects themselves with their own functions. Therefore, they are not classified separately from the other parts (features), and the whole set of features given in the distinctive part of claims of the invention that differ from the known technical solutions has not been found in the prior art patent documentation and other sources of scientific, technical and other information, therefore the provided technical solution corresponds to the criterion of “inventive step”.

### BRIEF DESCRIPTION OF THE DRAWINGS

The further essence of the provided technical solution is explained by means of the drawings illustrating the following:

FIG. 1—a schematic top view of parts of a damless hydroelectric power plant and functional units thereof;

FIG. 2—a schematic side view of FIG. 1.

### DESCRIPTION OF PREFERRED EMBODIMENTS

The provided damless hydroelectric power plant comprises a housing 1 with an annular part provided in the form of a tunnel 2 for receiving a bladed wheel 3 with rotary blades 4. On vertical struts 5 of the tunnel 2, annular support guides 6 are provided supporting the bladed wheel 3 by means of support rollers 7 with springs, having both horizontal and vertical rotation axes. On vertical struts 8 of the bladed wheel 3 outer rim, in the zone of the flow of water passing through the bladed wheel 3, gear sectors 9 are provided for pulling a step chain 10 of the first stage of the kinematic scheme for the torque transmission from the bladed wheel 3 to sprockets 11 provided on a shaft 12. The tension of the branches of the step chain 10 is controlled by a tensioning device 13. At the upper end of the shaft 12, there is a frame 14 with the gear sectors 9 that act as a large diameter drive sprocket of the second stage of the kinematic scheme for the torque transmission with the chain 15 to a driven sprocket 16 attached to the shaft of a rotation multiplier 17 wherefrom the rotation is transmitted to an electric power generator 18.

Rigidity of the annular part of the damless hydroelectric power plant housing 1 made in the form of a tunnel 2 is reinforced with a beam tension members 19 similar to bicycle wheel spokes connecting beam struts of the tunnel 2 with a central bushing 20.

The housing 1 of the damless hydroelectric power plant is provided with barriers 21 acting as a diffuser, which forms a flow of water passing through the bladed wheel 3, sealed containers 22 of a constant volume of air, whose total buoyancy force is numerically somewhat less than the weight of the whole damless hydroelectric power plant, and sealed containers 23 of a variable volume of air, allowing for placing the damless hydroelectric power plant within the flow of water. Keeping the damless hydroelectric power plant at the same place within the flow of water is provided by anchor gears with flexible connections of any known design (not shown).

The provided damless hydroelectric power plant is operated as follows.

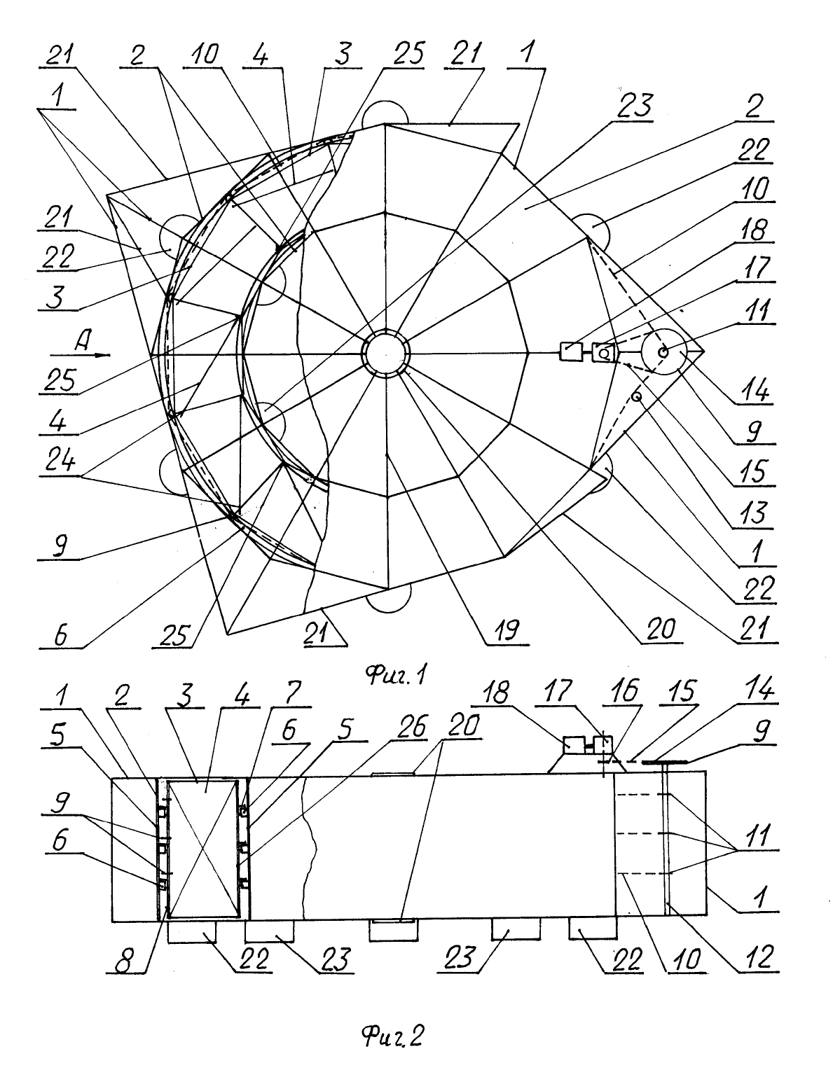

The damless hydroelectric power plant with the blades 4 fixed in the disabled state, is towed in floating configuration to its operation place where the anchor gears have been previously mounted, when containers 23 of a variable volume of air are completely filled with air. At the operation place the hydroelectric power plant is connected with anchor gears by means of flexible connections, and is oriented against the flow (against the arrow A in FIG. 1), the blades 4 are unblocked, the electric power generator 18 is connected to the cable and, through adjusting the tension of the flexible connections of the anchor gears and due to the adjustable water supply of the container 23, the damless hydroelectric power plant is submersed up to the required depth. Keeping the hydroelectric power plant at this depth is performed by means of the flexible connections of the anchor gears that prevent the hydroelectric power plant from moving caused by the current pressure and the excessive lifting force generated by the containers. The flow of water penetrating through the barriers 21 (the diffuser) (in the direction of arrow A) into the bladed wheel 3, affects the blades 4 of the active part of the bladed wheel 3 and swings them around an axis 24 in such a way that they abut by their movable end against stops 25 located on vertical struts 26 of the inner rim of the bladed wheel 3, thus forming a bucket space in the sectors of the bladed wheel 3 (the sides of the sector are closed with a sheet, and the blade 4 covers the bottom of the sector), and thereby increasing the force action of the flow of water on the bladed wheel 3 in the tunnel 2 around its geometric rotation axis. In addition, the blades 4, which are in the passive part of the bladed wheel 3 rotating in the direction opposite to the direction of the flow of water, rotate about their axis 24 each in its sector in such a way that the bucket bottom turns open, resulting in a decreasing resistance to rotation of the bladed wheel 3.

When the impeller 3 rotates, the gear sectors 9 attached to the vertical struts 8 of the of the bladed wheel 3 outer rim pull the branches of the step chain 10, thereby causing the rotation of the driven sprockets 11 attached to the shaft 12, which rotation is kinematically transmitted to the electric power generator 18.

### Technological Advantages of the Invention

The technical result of the provided solution consists in widening of the field of application and increasing of the technological and economical characteristics of the damless hydroelectric power plant due to improvement of force interaction between contact units, increasing technological effectiveness of manufacturing, assembling and adjustment, as well as maintenance and reparation at the operation place of the damless hydroelectric power plant.

1. A damless hydroelectric power plant with a housing containing an annular support guide supporting a bladed wheel with a vertical rotation axis and rotary blades, a driven sprocket support of chain transmission, diffusers for forming a flow of water passing through the bladed wheel, a container of an adjustable volume of air and anchor gears, wherein a part of the housing of the hydroelectric power plant, in which the bladed wheel is placed, is in the form of an annular tunnel, the annular support guides, on which the bladed wheel is supported by means of support rollers, are fixed in several rows on vertical struts of the tunnel inside the latter on both sides thereof, while the annular tunnel structure is connected to a central bushing through tension members similar to bicycle wheel spokes, and to the containers, some of which contain a constant volume of air, thereby providing the hydroelectric power plant with buoyancy, which is a bit lower than zero buoyancy, and the others contain an adjustable volume of air, allowing for locating the hydroelectric power plant inside the flow of water, wherein, in each wheel sector, the bladed wheel comprises several rows of the support rollers fixed on the vertical struts on the outside of the outer and inner wheel rims and having both horizontal and vertical rotation axes and provided with springs through which the wheel cooperates with the annular support guides of the tunnel, and gear sectors arranged in several rows fixed on the vertical struts of the outer wheel rim on each wheel sector and allowing for pulling the chains kinematically connected with a submersible rotation multiplier and a submersible electric power generator when rotating the bladed wheel.
